(19) United States
(12) Patent Application Publication
(10) Pub. No.: US 2003/0048380 A1
(43) Pub. Date: Mar. 13, 2003

(54) Self provisioning Set-Top Box

(76) Inventor: Yuriko Tamura, San Diego, CA (US)

Correspondence Address: MILLER PATENT SERVICES, 2500 DOCKERY LANE, RALEIGH, NC, 27606, US

(21) Appl. No.: 09/950,760

(22) Filed: Sep. 12, 2001

(51) Int. Cl. H04N 7/16; G06F 3/00; H04N 5/445; G06F 13/00; H04N 7/173

(52) U.S. Cl. 348/552; 725/50; 725/6; 725/25; 725/132; 725/111

(57) ABSTRACT

A self provisioning television Set-Top Box. The STB has an interface that couples the STB to a service provider and incorporates a cable modem. A programmed processor boots from a boot ROM and carries out a process for self provisioning in the event the STB is new and not set up to use the current service provider. The process includes initiating communication with the service provider using the cable modem and sending equipment identifying information including a Set-Top Box serial number and a smart card identifier to the service provider. The service provider replies with system specific information including an application server identifier from the service provider. The STB then sends a user profile to the service provider, and the service provider replies by sending account information including an account identifier.

### FIELD OF THE INVENTION

This invention relates generally to the field of cable television. More particularly, this invention relates to a television Set-Top Box or other receiver device that automatically configures itself to operate within multiple operating environments.

### BACKGROUND OF THE INVENTION

Television Set-Top Boxes (STB) have traditionally been manufactured in a manner that makes them operate only in a specified cable system. Recent changes in regulations require that such devices be able to operate in multiple cable systems. This permits a user to purchase a STB from any retail outlet and connect it directly to any of several cable systems without need for a service call or special order or visit to a cable company. Since the operating parameters for each cable system can vary significantly, a customer might be required to take a Set-Top Box to a cable system office to have it properly configured, or might be required to undergo a lengthy and complex setup procedure in order to make a particular STB function properly if the user establishes a new account or moves to another area serviced by a different cable television system.

### SUMMARY OF THE INVENTION

The present invention relates generally to a self provisioning Set-Top Box or other television receiver device. Objects, advantages and features of the invention will become apparent to those skilled in the art upon consideration of the following detailed description of the invention.

In one embodiment of the present invention a self provisioning television Set-Top Box or other television receiver device is provided. The STB has an interface that couples the STB to a service provider and incorporates a cable modem. A programmed processor boots from a boot ROM and carries out a process for self provisioning in the event the STB is new and not set up to use the current service provider. The process includes initiating communication with the service provider using the cable modem and sending equipment identifying information including a Set-Top Box serial number and a smart card identifier to the service provider. The service provider replies with system specific information including an application server identifier from the service provider. The STB then sends a user profile to the service provider, and the service provider replies by sending account information including an account identifier.

A method of self-provisioning a television receiver device, consistent with an embodiment of the present invention, includes booting a processor from a memory device storing boot-up code; the processor determining that the receiver device has not been set up to operate in a current television operating environment; and the processor running a self provisioning process that interacts with a service provider to set up the receiver device to properly receive and decode television transmissions in the current television operating environment.

A method carried out at a service provider of self-provisioning a television receiver device, in a manner consistent with an embodiment of the present invention includes receiving equipment identifying information from the television receiver device; sending system specific information to the television receiver device; receiving a user profile from the television receiver device; and sending account information to the television receiver device.

A method of self-provisioning a television Set-Top Box, consistent with an embodiment of the present invention includes booting a processor from a memory device storing boot-up code; the processor determining that the Set-Top Box has not been set up to operate in a current television operating environment; and the processor running a self provisioning process that interacts with a service provider to set up Set-Top Box to properly receive and decode television transmissions in the current television operating environment. The self provisioning process may, for example, include sending equipment identifying information to the service provider; receiving system specific information from the service provider; sending a user profile to the service provider; and receiving account information from the service provider.

Another method of self-provisioning a television Set-Top Box, consistent with an embodiment of the invention includes booting a processor from a memory device storing boot-up code; the processor determining that the Set-Top Box has not been set up to operate in a current television operating environment; the processor running a self provisioning process that interacts with a service provider using a cable modem to set up the Set-Top Box to properly receive and decode television transmissions in the current television operating environment, wherein the self provisioning process comprises: obtaining an IP address from a DHCP server; sending equipment identifying information including a television receiver device serial number and a smart card identifier to the service provider using a notification message; receiving system specific information including an application server identifier from the service provider; receiving a user interface from the service provider for entry of a user profile; sending the user profile including information identifying a user to the service provider, the user profile being entered into the user interface; and receiving account information including an account identifier from the service provider.

A self provisioning television receiver device, consistent with certain embodiments of the present invention has an interface that couples the television receiver device to a service provider. A memory device stores boot-up code and a self provisioning process. A programmed processor carries out a sequence of instructions to implement a process comprising: booting from the boot-up code; determining that the receiver device has not been set up to operate in a current television operating environment; and running the self provisioning process that interacts with a service provider through the interface to set up the receiver device to properly receive and decode television transmissions in the current television operating environment.

A self provisioning television Set-Top Box, consistent with an embodiment of the present invention has an interface that couples the television Set-Top Box to a service provider. A memory device stores boot-up code and a self provisioning process. A programmed processor carries out a sequence of instructions to implement a process comprising: booting from the boot-up code; determining that the television Set-Top Box has not been set up to operate in a current television operating environment; running the self provisioning process that interacts with a service provider through the interface to set up the Set-Top Box to properly receive and decode television transmissions in the current television operating environment; and wherein the self provisioning process comprises: sending equipment identifying information to the service provider; receiving system specific information from the service provider; sending a user profile to the service provider; and receiving account information from the service provider.

Another self provisioning television Set-Top Box, consistent with embodiments of the present invention has an interface that couples the television Set-Top Box to a service provider. A memory device stores boot-up code and a self provisioning process. The STB has means for carrying out a sequence of instructions to implement a process comprising: booting from the boot-up code; determining that the television Set-Top Box has not been set up to operate in a current television operating environment; and running the self provisioning process that interacts with a service provider through the interface to set up the Set-Top Box to properly receive and decode television transmissions in the current television operating environment.

Another self provisioning television Set-Top Box, consistent with embodiments of the present invention has an interface that couples the television Set-Top Box to a service provider, the interface having a cable modem, A memory device stores boot-up code and a self provisioning process. A programmed processor carries out a sequence of instructions to implement a process comprising: booting from the boot-up code; determining that the television Set-Top Box has not been set up to operate in a current television operating environment; running the self provisioning process that interacts with a service provider through the interface to set up the Set-Top Box to properly receive and decode television transmissions in the current television operating environment; and wherein the self provisioning process comprises: initiating communication with the service provider using the cable modem; sending equipment identifying information including a Set-Top Box serial number and a smart card identifier to the service provider; receiving system specific information including an application server identifier from the service provider; sending a user profile to the service provider; and receiving account information including an account identifier from the service provider.

Any of the above methods can be carried out by a set of instructions stored in any suitable storage medium for execution on a programmed processor or transmitted over a suitable communication medium.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a simplified block diagram of an exemplary television Set-Top Box, consistent with an embodiment of the present invention.

FIG. 2 is a flow chart of an exemplary overall process for self-provisioning consistent with an embodiment of the present invention.

FIG. 3 is a flow chart of an exemplary process for a self-provisioning routine consistent with an embodiment of the present invention.

FIG. 4 is a flow chart of an exemplary process carried out at a service provider for interacting with a self-provisioning routine consistent with an embodiment of the present invention.

FIG. 5 is a flow chart of an exemplary detailed process for self-provisioning consistent with an embodiment of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

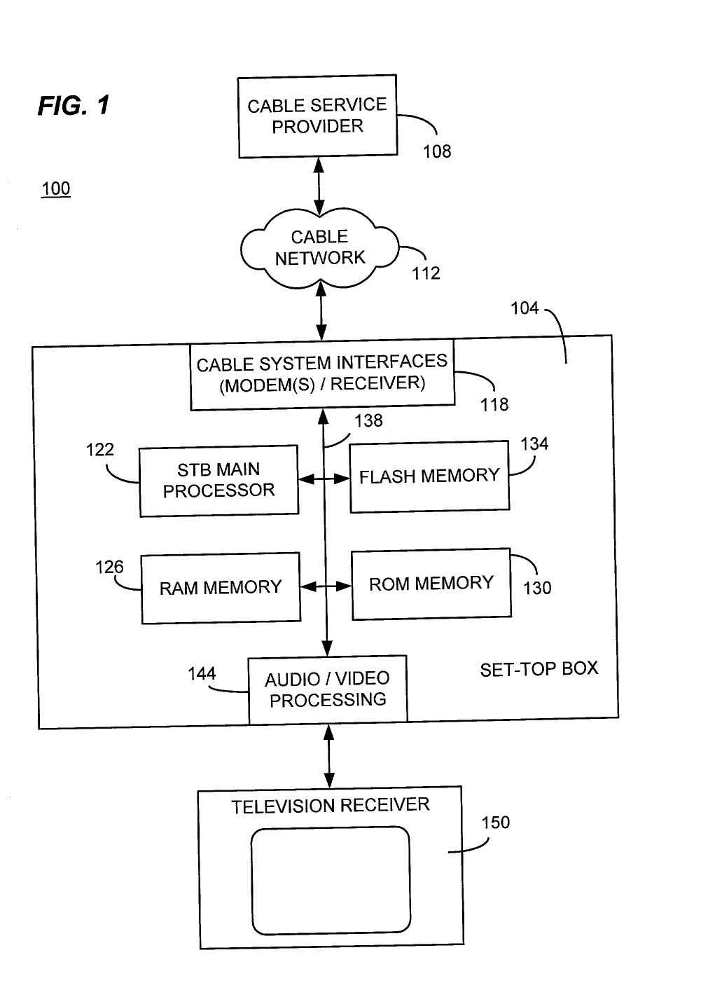

Turning now to FIG. 1, a simplified block diagram of an exemplary cable television arrangement 100 with a Set-Top Box 104 is illustrated. STB 104 connects to a cable system service provider 108 via a cable network 112. An interface to the cable system is provided at STB 104 in the form of a television receiver (tuner) as well as potentially in-band and out-of-band modems, collectively shown as interfaces 118. STB 104 incorporates an internal main processor 122 with associated RAM memory 126, ROM memory 130 and FLASH memory 134. The processor 122 is interconnected with the associated memory in a conventional manner using a single or multiple bus connections depicted as 138. Audio and video information is processed using audio/video (A/V) processing circuitry 144 that receives such A/V signals from the cable system interface 118. The processed A/V information is then delivered to a television receiver 150 or monitor and audio system for presentation to the user.

While the above exemplary system including STB 104 is illustrative of the basic components of a digital Set-Top Box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a STB using a multiple bus architecture with a high level of encryption between components for added security. This application is hereby incorporated by reference as though disclosed fully herein.

While the present invention will be described herein in connection with self provisioning of a television STB such as 104, the invention itself is not to be considered limited to such a STB environment. It is anticipated that many functions of the STB 104 will be incorporated into various television receiver devices themselves (e.g., the television set, a personal video recorder (PVR) or a video tape recorder (VTR)). Accordingly, the present invention contemplates such embodiments as fully equivalent to the STB environment of the exemplary embodiment.

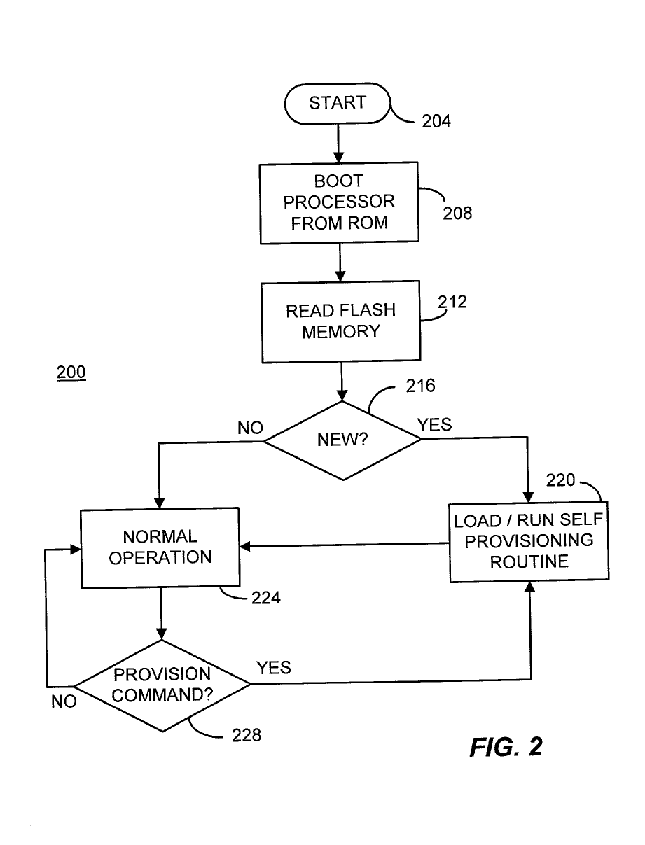

When the user obtains a new STB and wishes to configure the STB to operate within his or her local cable television system, the present invention utilizes a self provisioning process that simplifies the configuration. FIG. 2 illustrates an exemplary overall process 200 used to configure the STB 104. The process starts at 204 with connection and powering up of the STB. When powered up, the STB boots up processor 122 from a boot program stored in ROM 130. As a part of the boot process, the processor 122 inspects information stored in the Flash memory 134 to determine if the STB 104 has been configured to operate in the current cable system. This can be determined by a lack of certain information stored in the Flash memory 134, or by a specific flag set in a specified location of the Flash memory 134. In either case, when the processor 122 determines that the STB 104 is new or has not been configured at 216, a self provisioning routine is loaded from ROM (or Flash memory) and run at 220. This self provisioning routine interacts with the cable service provider or a clearing house for the provider to obtain information needed to configure the STB and to establish or activate a user account to permit the STB 104 to function in the current cable system environment and thus properly receive and decode television signals transmitted over the cable system 112.

Once the STB 104 is configured, normal operation ensues at 224. If at a later time, an update is required, or if the STB is moved to another system, a provisioning command can be issued (e.g., from a setup menu) at 228 to run the self provisioning routine again. When this self provisioning routine is run on the same system, the routine updates information for the service provider or the STB. When the self provisioning routine is run and a different system is encountered, the entire self provisioning process is carried out as if the STB were new and unconfigured.

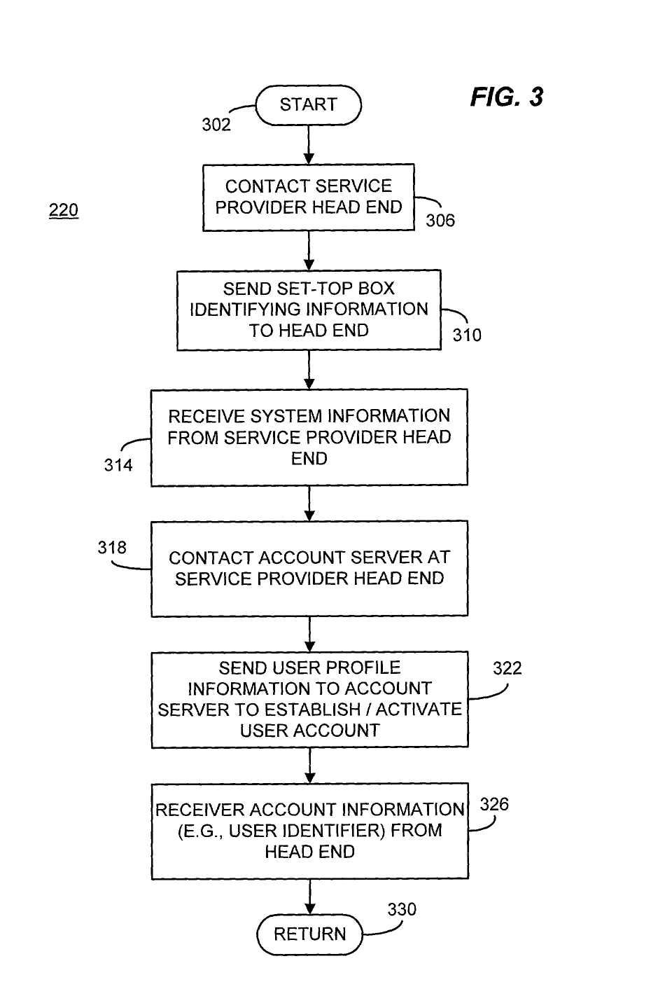

FIG. 3 is a flow chart illustrating in general terms the routine 220 carried out in the STB 104 to effect the self provisioning in one embodiment consistent with the present invention. The routine is invoked at 302 after which the STB 104 contacts the service provider at 306. At 310, once communication is established between the STB 104 and the service provider, identifying information such as serial number, device type, smart card identifier, etc. is sent from the STB to the service provider head end. The service provider responds at 314 with system information required by the STB 104 in order properly communicate with the service provider when operational. The STB then contacts an account server at 318 residing at the service provider and sends a user profile (provided by the user) at 322. The user profile can incorporate many pieces of information including, but not limited to, name, address, credit card number, telephone number, as well as any viewing preferences that the system requests in order to establish a user profile within the operational parameters of the cable system. This information is used to establish an account with the service provider and may involve information used to establish credit worthiness. At 326, the STB 104 receives account information from the service provider (e.g., an account number and other relevant information) to complete establishment and/or activation of an account. The routine returns to the main program at 330.

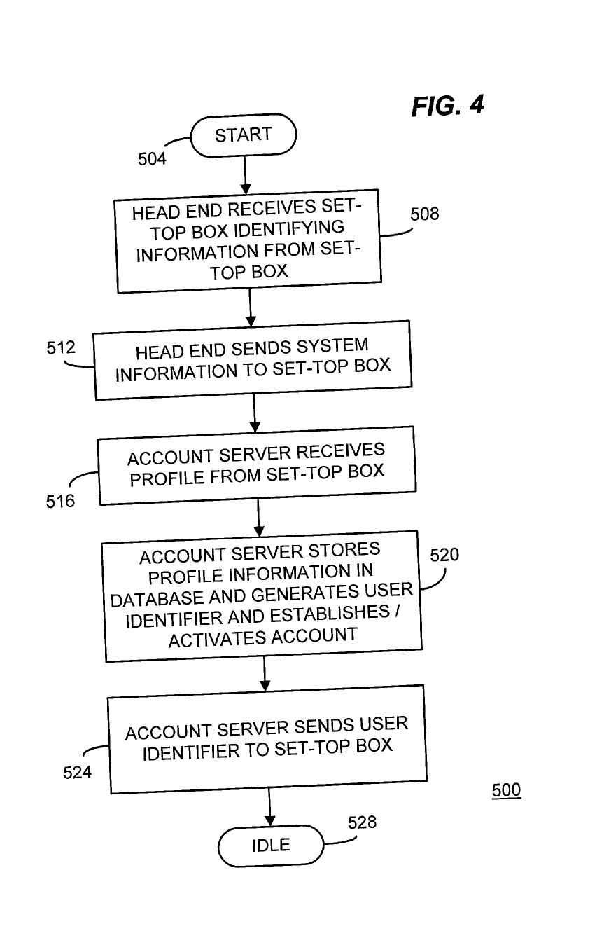

FIG. 4 depicts an exemplary process 500 used by a service provider in facilitating the self provisioning routine just described starting at 504. When the service provider receives the STB identifying information from STB 104 at 508, it replies with system information at 512 as previously described. An account server receives the user profile from the STB 104 at 516 and stores the profile information in a database at 520. In some embodiments, the account server, either with or without human intervention, may verify credit at this stage. Once the account server determines that an account can be established at 520, a user identifier is generated and sent to the STB 104 at 524. The service provider then goes idle or processes other requests at 528.

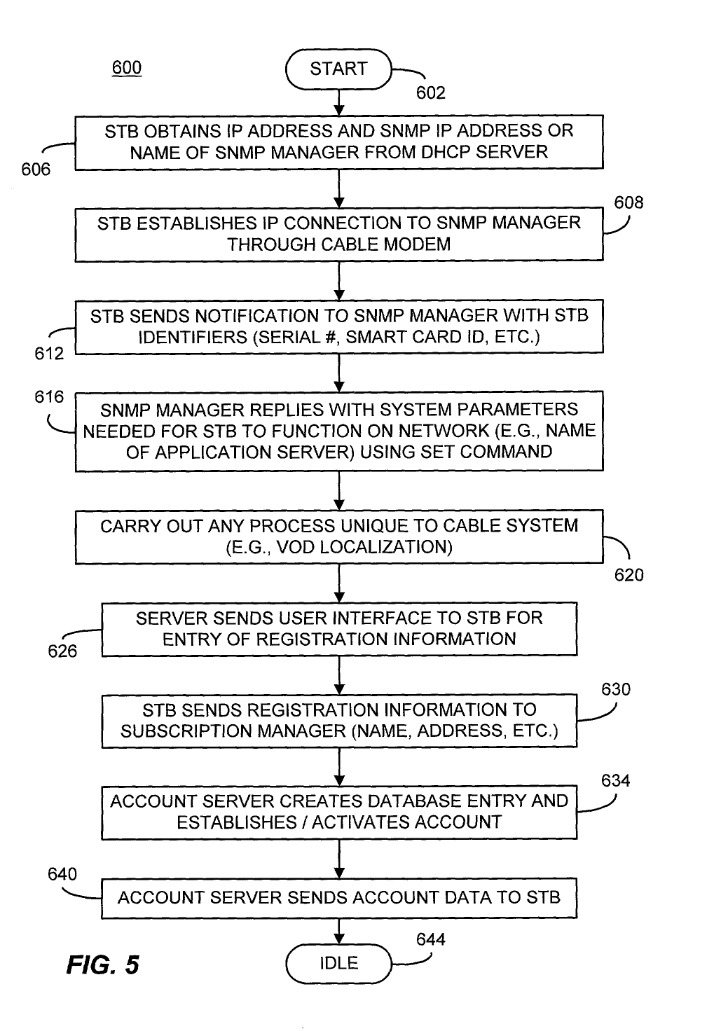

Many variations of this process are possible, depending upon the sophistication and complexity of the range of services provided by the service provider. FIG. 5 depicts an exemplary process 600 that a STB might go through to implement a self provisioning process with a specific service provider. The process begins at 602 with powering up the STB. At 606, the STB obtains an IP (Internet Protocol) address and SNMP (Simple Network Management Protocol) IP address or name from a DHCP (Dynamic Host Configuration Protocol) manager server. Using this address information, the STB 104 establishes an IP connection with the SNMP manager using a cable modem integral with the cable interface 118 at 608. The STB 104 then sends a trap or inform notification to the SNMP manager along with STB identifiers (e.g., serial number and Smart Card identifiers) at 612. A trap or inform notification is used to notify the head of the STB. The SNMP manager replies to the trap or inform notification at 616 with system parameters used by the STB to function within the network using a SET command (The “SET” command is a part of the SNMP protocol.).

At 620, the system carries out any process unique to the current operating environment. In one embodiment, a VOD (Video-On-Demand) localization process is carried out to enable the STB 104 to provide VOD programming. In other embodiments, special software or encryption/decryption algorighms may be downloaded to the STB 104. Other variations will occur to those skilled in the art.

At 626, a server at the service provider sends a user interface (UI) to the STB 104 for display to the user to enable entry of registration information (User profile information) to permit establishment of an account for the user. At 630, the user sends such registration information to the service provider's subscription manager/account server. The subscription manager/account server then creates a database entry at 634 to establish and/or activate an account. The account server then sends account data such as an account number back to the STB 104 at 640. The process then goes idle awaiting a next self provisioning at 644.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of self-provisioning a television receiver device, comprising:
booting a processor from a memory device storing boot-up code;
the processor determining that the receiver device has not been set up to operate in a current television operating environment; and
the processor running a self provisioning process that interacts with a service provider to set up the receiver device to properly receive and decode television transmissions in the current television operating environment.

2. The method according to claim 1, wherein the self provisioning process comprises:
sending equipment identifying information to the service provider;
receiving system specific information from the service provider;
sending a user profile to the service provider; and
receiving account information from the service provider.

3. The method according to claim 2, wherein the television receiver device comprises one of a television set, a television Set-Top Box, a personal video recorder and a video tape recorder.

4. The method according to claim 2, wherein the equipment identifying information comprises a television receiver device serial number.

5. The method according to claim 2, wherein the equipment identifying information comprises a smart card identifier.

6. The method according to claim 2, wherein the equipment identifying information is transmitted to the service provider using a notification message.

7. The method according to claim 2, wherein the system specific information comprises an application server identifier.

8. The method according to claim 2, wherein the user profile information comprises information identifying a user.

9. The method according to claim 8, wherein the user profile information is stored in a database at the service provider.

10. The method according to claim 2, wherein the user profile information is entered by the user into a user interface received from the service provider.

11. The method according to claim 2, wherein the account information comprises an account identifier.

12. The method according to claim 1, wherein the processor initiates communication with the service provider using an IP address obtained from a DHCP server.

13. The method according to claim 1, wherein the processor initiates communication with the service provider using a cable modem.

14. An electronic storage medium storing instructions which, when executed on a programmed processor, carry out a method of self-provisioning a television receiver device, comprising:
booting a processor from a memory device storing boot-up code;
the processor determining that the receiver device has not been set up to operate in a current television operating environment; and
the processor running a self provisioning process that interacts with a service provider to set up the receiver device to properly receive and decode television transmissions in the current television operating environment.

15. The method according to claim 14, wherein the self provisioning process comprises:
sending equipment identifying information to the service provider;
receiving system specific information from the service provider;
sending a user profile to the service provider; and
receiving account information from the service provider.

16. A method carried out at a service provider of self-provisioning a television receiver device, comprising:
receiving equipment identifying information from the television receiver device;
sending system specific information to the television receiver device;
receiving a user profile from the television receiver device; and
sending account information to the television receiver device.

17. The method according to claim 16, wherein the television receiver device comprises one of a television set, a television Set-Top Box, a personal video recorder and a video tape recorder.

18. The method according to claim 16, wherein the equipment identifying information comprises a television receiver device serial number.

19. The method according to claim 16, wherein the equipment identifying information comprises a smart card identifier.

20. The method according to claim 16, wherein the equipment identifying information is received by the service provider in a notification message.

21. The method according to claim 16, wherein the system specific information comprises an application server identifier.

22. The method according to claim 16, wherein the user profile information comprises information identifying a user.

23. The method according to claim 16, further comprising storing the user profile information in a database at the service provider.

24. The method according to claim 16, further comprising sending a user interface received from the service provider to the television receiver device for entry of the user profile information.

25. The method according to claim 16, wherein the account information comprises an account identifier.

26. The method according to claim 16, communication between the service provider and the television receiver device is carried out using an IP address obtained by the television receiver device from a DHCP server.

27. The method according to claim 16, wherein the television receiver device initiates communication with the service provider using a cable modem.

28. An electronic storage medium storing instructions which, when executed on a programmed processor, carry out a method carried out at a service provider of self-provisioning a television receiver device, comprising:
receiving equipment identifying information from the television receiver device;
sending system specific information to the television receiver device;
receiving a user profile from the television receiver device; and
sending account information to the television receiver device.

29. A method of self-provisioning a television Set-Top Box, comprising:
booting a processor from a memory device storing boot-up code;
the processor determining that the Set-Top Box has not been set up to operate in a current television operating environment; and
the processor running a self provisioning process that interacts with a service provider to set up Set-Top Box to properly receive and decode television transmissions in the current television operating environment.

30. The method according to claim 29, wherein the self provisioning process comprises:
sending equipment identifying information to the service provider;
receiving system specific information from the service provider;
sending a user profile to the service provider; and
receiving account information from the service provider.

31. The method according to claim 29, wherein the equipment identifying information comprises a television receiver device serial number.

32. The method according to claim 29, wherein the system specific information comprises an application server identifier.

33. The method according to claim 29, wherein the processor initiates communication with the service provider using a cable modem.

34. A method of self-provisioning a television Set-Top Box, comprising:
booting a processor from a memory device storing boot-up code;
the processor determining that the Set-Top Box has not been set up to operate in a current television operating environment;
the processor running a self provisioning process that interacts with a service provider using a cable modem to set up the Set-Top Box to properly receive and decode television transmissions in the current television operating environment, wherein the self provisioning process comprises:
obtaining an IP address from a DHCP server;
sending equipment identifying information including a television receiver device serial number and a smart card identifier to the service provider using a notification message;
receiving system specific information including an application server identifier from the service provider;
receiving a user interface from the service provider for entry of a user profile;
sending the user profile including information identifying a user to the service provider, the user profile being entered into the user interface; and
receiving account information including an account identifier from the service provider.

35. An electronic storage medium storing instructions which, when executed on a programmed processor, carry out a method of self-provisioning a television Set-Top Box, comprising:
booting a processor from a memory device storing boot-up code;
the processor determining that the Set-Top Box has not been set up to operate in a current television operating environment;
the processor running a self provisioning process that interacts with a service provider using a cable modem to set up the Set-Top Box to properly receive and decode television transmissions in the current television operating environment, wherein the self provisioning process comprises:
obtaining an IP address from a DHCP server;
sending equipment identifying information including a television receiver device serial number and a smart card identifier to the service provider using a notification message;
receiving system specific information including an application server identifier from the service provider;
receiving a user interface from the service provider for entry of a user profile;
sending the user profile including information identifying a user to the service provider, the user profile being entered into the user interface; and
receiving account information including an account identifier from the service provider.

36. A self provisioning television receiver device, comprising:
an interface that couples the television receiver device to a service provider;
a memory device storing boot-up code and a self provisioning process;
a programmed processor carrying out a sequence of instructions to implement a process comprising:
booting from the boot-up code;
determining that the receiver device has not been set up to operate in a current television operating environment; and
running the self provisioning process that interacts with a service provider through the interface to set up the receiver device to properly receive and decode television transmissions in the current television operating environment.

37. The apparatus according to claim 36, wherein the self provisioning process comprises:
sending equipment identifying information to the service provider;
receiving system specific information from the service provider;
sending a user profile to the service provider; and
receiving account information from the service provider.

38. The apparatus according to claim 37, wherein the television receiver device comprises one of a television set, a television Set-Top Box, a personal video recorder and a video tape recorder.

39. The apparatus according to claim 37, wherein the equipment identifying information comprises a television receiver device serial number.

40. The apparatus according to claim 37, wherein the equipment identifying information comprises a smart card identifier.

41. The apparatus according to claim 37, wherein the system specific information comprises an application server identifier.

42. The apparatus according to claim 37, wherein the account information comprises an account identifier.

43. The apparatus according to claim 37, further comprising a cable modem forming a part of the interface, and wherein the processor initiates communication with the service provider using the cable modem.

44. A self provisioning television Set-Top Box, comprising:
an interface that couples the television Set-Top Box to a service provider;
a memory device storing boot-up code and a self provisioning process;
a programmed processor carrying out a sequence of instructions to implement a process comprising:
booting from the boot-up code;
determining that the television Set-Top Box has not been set up to operate in a current television operating environment;
running the self provisioning process that interacts with a service provider through the interface to set up the Set-Top Box to properly receive and decode television transmissions in the current television operating environment; and
wherein the self provisioning process comprises:
sending equipment identifying information to the service provider;
receiving system specific information from the service provider;
sending a user profile to the service provider; and
receiving account information from the service provider.

45. The apparatus according to claim 44, wherein the equipment identifying information comprises a television Set-Top Box serial number.

46. The apparatus according to claim 44, wherein the equipment identifying information comprises a smart card identifier.

47. The apparatus according to claim 44, wherein the system specific information comprises an application server identifier.

48. The apparatus according to claim 44, wherein the account information comprises an account identifier.

49. The apparatus according to claim 44, further comprising a cable modem forming a part of the interface, and wherein the processor initiates communication with the service provider using the cable modem.

50. A self provisioning television Set-Top Box, comprising:
an interface that couples the television Set-Top Box to a service provider;
a memory device storing boot-up code and a self provisioning process;
means for carrying out a sequence of instructions to implement a process comprising:
booting from the boot-up code;
determining that the television Set-Top Box has not been set up to operate in a current television operating environment; and
running the self provisioning process that interacts with a service provider through the interface to set up the Set-Top Box to properly receive and decode television transmissions in the current television operating environment.

51. The apparatus according to claim 51, wherein the self provisioning process comprises:
sending equipment identifying information to the service provider;
receiving system specific information from the service provider;
sending a user profile to the service provider; and
receiving account information from the service provider.

52. A self provisioning television Set-Top Box, comprising:
an interface that couples the television Set-Top Box to a service provider, said interface having a cable modem;
a memory device storing boot-up code and a self provisioning process;
a programmed processor carrying out a sequence of instructions to implement a process comprising:
booting from the boot-up code;
determining that the television Set-Top Box has not been set up to operate in a current television operating environment;
running the self provisioning process that interacts with a service provider through the interface to set up the Set-Top Box to properly receive and decode television transmissions in the current television operating environment; and
wherein the self provisioning process comprises:
initiating communication with the service provider using the cable modem;
sending equipment identifying information including a Set-Top Box serial number and a smart card identifier to the service provider;
receiving system specific information including an application server identifier from the service provider;
sending a user profile to the service provider; and
receiving account information including an account identifier from the service provider.
